(19) United States
(12) Patent Application Publication
(10) Pub. No.: US 2024/0185738 A1
(43) Pub. Date: Jun. 6, 2024

(54) GAS SAFETY MANAGEMENT METHODS AND INTERNET OF THINGS SYSTEMS FOR GAS SAFETY TRAINING

(71) Applicant: CHENGDU QINCHUAN IOT TECHNOLOGY CO., LTD., Chengdu (CN)

(72) Inventors: Zehua SHAO, Chengdu (CN); Haitang XIANG, Chengdu (CN); Bin LIU, Chengdu (CN)

(73) Assignee: CHENGDU QINCHUAN IOT TECHNOLOGY CO., LTD., Chengdu (CN)

(21) Appl. No.: 18/067,006

(22) Filed: Dec. 15, 2022

(30) Foreign Application Priority Data
Dec. 6, 2022 (CN) 202211556281.X

(51) Int. Cl. G09B 19/00

(52) U.S. Cl. CPC G09B 19/00; G16Y 40/50

(57) ABSTRACT

The embodiments of the present disclosure provide a gas safety management method and an Internet of things system for gas safety training. The gas safety management method for gas safety training may include: obtaining gas usage data of at least one gas-consuming end; determining a user type of each of the at least one gas-consuming end based on the gas usage data of the at least one gas-consuming end, and determining a gas safety training program corresponding to each user type; pushing a safety training to a user terminal based on the gas safety training program; obtaining feedback information from the user terminal; determining a gas safety detection frequency of the gas-consuming end of each user type, and a gas safety risk level of the gas-consuming end of each user type based on the feedback information and the gas usage data corresponding to each user type.

### CROSS-REFERENCE TO RELATED DISCLOSURES

This application claims priority to Chinese Patent Application No. 202211556281.X, filed on Dec. 6, 2022, the entire contents of which are hereby incorporated by reference.

### TECHNICAL FIELD

The present disclosure relates to the field of gas safety management, in particular to gas safety management methods and the Internet of Things systems for gas safety training.

### BACKGROUND

At present, the gas company's household safety management of gas is mainly to carry out gas safety knowledge popularization education to a wide range of gas users through forms such as articles, videos, and message notifications. For different user types (e.g., factories, residents, businesses, etc. type), users with different gas types and different usage habits lack targeted safety training.

Therefore, it is necessary to propose gas safety management methods and the Internet of Things systems for gas safety training, realize targeted matching of appropriate training programs and push frequencies based on different user features and gas features to improve training efficiency. At the same time, the gas safety detection frequency may also be determined based on the occurrence probability of safety risks to comprehensively improve the safety of gas use.

### SUMMARY

One or more embodiments of the present disclosure provide a gas safety management method for gas safety training. The gas safety management method for gas safety training may include the following operations. Gas usage data of at least one gas-consuming end may be obtained, the gas usage data may include at least one of gas usage, gas alarm data, and gas maintenance data. A user type of each of the at least one gas-consuming end may be determined based on the gas usage data of the at least one gas-consuming end, and a gas safety training program corresponding to each user type may be determined, the gas safety training program may include at least one of a training object, a training time and a push frequency. A safety training may be pushed to a user terminal based on the gas safety training program. Feedback information may be obtained from the user terminal. A gas safety detection frequency of the gas-consuming end of each user type, and a gas safety risk level of the gas-consuming end of each user type based on the feedback information and the gas usage data corresponding to each user type may be determined.

One of the embodiments of the present disclosure provide a gas safety management Internet of Things system for gas safety training. The gas safety management Internet of Things system may include a smart gas user platform, a smart gas service platform, a smart gas safety management platform, a smart gas indoor device sensor network platform, a smart gas indoor device object platform. The smart gas indoor device object platform may be configured to obtain gas usage data of at least one gas-consuming end. The gas usage data may include at least one of gas usage, gas alarm data, and gas maintenance data. The smart gas indoor device sensor network platform may be configured to transmit the gas usage data of the at least one gas-consuming end to the smart gas safety management platform. The smart gas safety management platform may be configured to: determine a user type of each of the at least one gas-consuming end based on the gas usage data of the at least one gas-consuming end, and determine a gas safety training program corresponding to each user type, the gas safety training program may include at least one of a training object, a training time and a push frequency, push a safety training to a user terminal based on the gas safety training program, determine a gas safety detection frequency of the gas-consuming end of each user type, and a gas safety risk level of the gas-consuming end of each user type based on feedback information of each user type on the safety training and the gas usage data corresponding to each user type. The smart gas service platform may be configured to feed back the gas safety training program corresponding to each user type, the gas safety detection frequency of the gas-consuming end of each user type, and the gas safety risk level of the gas-consuming end of each user type to the smart gas user platform based on the smart gas service platform. The smart gas user platform may be configured to obtain the feedback information of each user type on the safety training.

One or more embodiments of the present disclosure provide a non-transitory computer-readable storage medium storing a set of instructions, when executed by at least one processor, causing the at least one processor to perform the gas safety management method for gas safety training.

### BRIEF DESCRIPTION OF THE DRAWINGS

The present disclosure may be further described by way of exemplary embodiments, which may be described in detail by means of the accompanying drawings. These embodiments are not limiting, and in these embodiments, the same numbers refer to the same structures, wherein:

FIG. 1 is a schematic diagram illustrating a gas safety management Internet of Things system for gas safety training according to some embodiments of the present disclosure;

FIG. 2 is an exemplary flowchart illustrating a gas safety management method for gas safety training according to some embodiments of the present disclosure;

FIG. 3 is an exemplary flowchart illustrating determining a gas safety detection frequency according to some embodiments of the present disclosure;

FIG. 4 is a schematic diagram illustrating predicting an occurrence probability of a safety risk;

FIG. 5 is a schematic diagram illustrating determining a gas safety risk level according to some embodiments of the present disclosure.

### DETAILED DESCRIPTION

In order to more clearly illustrate the technical solutions of the embodiments of the present disclosure, the following will briefly introduce the drawings that demand to be used in the description of the embodiments. Obviously, the drawings in the following description are only some examples or embodiments of the disclosure. For those of ordinary skill in the art, without creative work, the disclosure can be applied to other similar scenarios according to these drawings. Unless it is obvious from the language environment or otherwise stated, the same reference numbers in the drawings represent the same structure or operation.

It should be understood that the “system”, “device”, “unit” and/or “module” used herein is a method for distinguishing different components, elements, parts, portions, or assemblies of different levels. However, if other words can achieve the same purpose, the words can be replaced by other expressions.

As shown in the present disclosure and the claims, unless the context clearly suggests exceptional circumstances, the words “a”, “an”, and/or “the” do not only specifically refer to the singular form, but also include the plural form; the plural form may be intended to include the singular form as well. Generally speaking, the terms “including,” “includes,” “include,” “comprise,” “comprises,” and “comprising,” only suggest that the operations and/or elements that have been clearly identified are included, but these operations and/or elements do not constitute an exclusive list, and the method, system, or device may also include other operations or elements.

Flowcharts are used in the present disclosure to describe operations performed by a system according to an embodiment of the present disclosure. It should be understood that the preceding or following operations are not necessarily performed in the exact order. Instead, the various operations may be processed in reverse order or simultaneously. Also, other operations may be added to these procedures, or an operation or operations may be removed from these procedures.

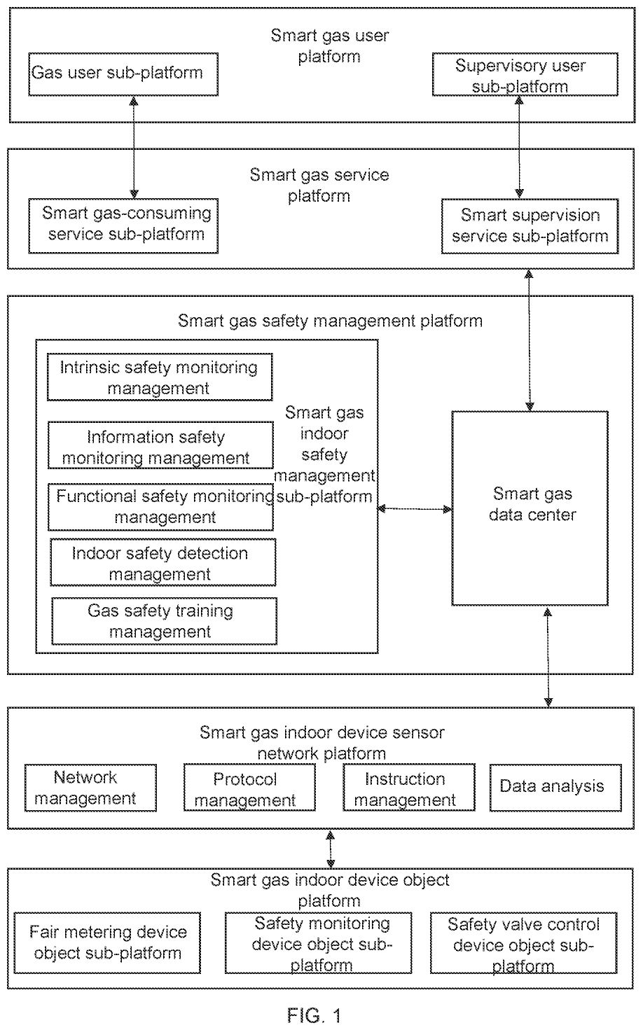

FIG. 1 is a schematic diagram illustrating a gas safety management Internet of Things system for gas safety training according to some embodiments of the present disclosure. The gas safety management Internet of Things system for gas safety training, may include a smart gas user platform, a smart gas service platform, a smart gas safety management platform, a smart gas indoor device sensor network platform, a smart gas indoor device object platform that interact in sequence.

The smart gas user platform may be a user-led platform. In some embodiments, the smart gas user platform may be configured as a terminal device.

In some embodiments, the smart gas user platform may include a gas user sub-platform, a supervisory user sub-platform, or the like.

The gas user sub-platform may be configured to provide gas-related data and gas problem solutions for gas users (e.g., gas consumers, etc.). For example, gas usage, gas leak solutions, etc. In some embodiments, the gas user sub-platform may further provide gas safety training content, etc., for the gas user. In some embodiments, the gas user sub-platform may correspond to and interact with the smart gas-consuming service sub-platform to obtain services for safe gas consumption.

The supervisory user sub-platform may be configured to supervise operations of the entire Internet of Things system for supervisory users (e.g., gas companies, etc.). For example, whether the supervision of the pipeline network is reasonable, and whether the related device is faulty, etc. In some embodiments, the supervisory user sub-platform may correspond to and interact with the smart supervision service sub-platform to obtain services required by safety supervision.

In some embodiments, the smart gas user platform may interact downward with the smart gas service platform. For example, indoor gas safety information and gas safety training programs uploaded by the smart gas service platform may be received. The indoor gas safety information may include abnormal gas information. For example, the gas usage, the usage time exceeds a usual usage threshold, etc.

The smart gas service platform may be a platform that provides users with services related to safe gas use. In some embodiments, the smart gas service platform may include a smart gas-consuming service sub-platform and a smart supervision service sub-platform.

The smart gas service sub-platform may correspond to the gas user sub-platform, and provide safe gas service for gas users. For example, gas safety training content may be upload to the user platform, etc. The smart supervision service sub-platform may correspond to the supervisory user sub-platform, and provide the supervision users with services required by safety supervision. For example, the supervision users may obtain information such as the layout of gas pipelines, use and maintenance of gas devices through the smart supervision service sub-platform.

In some embodiments, the smart gas service platform may interact downward with the smart gas safety management platform. For example, indoor gas safety information and gas safety training programs uploaded by the smart gas safety management platform may be received. In some embodiments, the smart gas service platform may further interact upward with the smart gas user platform. For example, indoor gas safety information and gas safety training content may be upload to the smart gas user platform, etc.

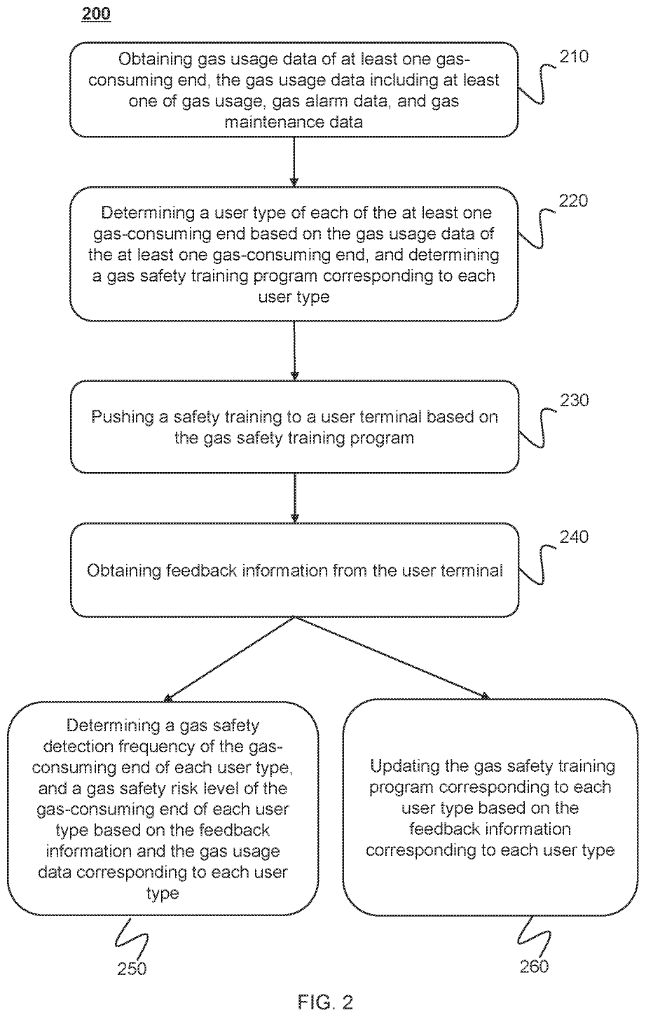

The smart gas safety management platform may be a platform for managing gas indoor safety. The indoor gas safety management may refer to perform processes, such as safety monitoring and abnormal alarming for gas indoor device. For example, the smart gas safety management platform may monitor whether there may be a gas leak and send a warning light to gas users after confirming the gas leak. In some embodiments, the smart gas safety management platform may further formulate different gas safety training programs for different types of gas users. More contents of related descriptions, reference may be found in FIG. 2 and its related descriptions.

In some embodiments, the smart gas safety management platform may include a smart gas indoor safety management sub-platform and a smart gas data center, or the like.

The smart gas indoor safety management sub-platform may be a sub-platform for the safety management of the indoor gas device of the gas user. In some embodiments, the smart gas indoor safety management sub-platform may include an intrinsic safety monitoring management module, an information safety monitoring management module, a functional monitoring management module, an indoor safety detection management module, or the like. The intrinsic safety monitoring management module may be a module for safety monitoring of the gas device itself. For example, monitoring and managing for explosion-proof safety such as mechanical leak, abnormal gas meter, valve control, etc. The information safety monitoring management module may be a module for monitoring and managing gas data information. For example, a module for securely managing information such as data anomalies, illegal device information, and illegal access. The functional monitoring management module may be a module for monitoring and managing the gas function. For example, functional safety monitoring and managing information such as, long-term unused gas, continuous flow overtime, flow overload, abnormally large flow, abnormally small flow, low air pressure, strong magnetic interference, and low voltage, etc. The indoor safety detection management module may be a module for managing the indoor gas safety status. For example, the safety detection time and safety detection frequency of indoor device of gas users may be managed.

In some embodiments, the smart gas indoor safety management sub-platform may further include a gas safety training management module. The gas safety training management module may be a module configured to formulate different gas safety training programs for different types of gas users. For example, the safety training management module may formulate related training programs, such as the correct use and maintenance of gas device for users whose gas devices are easily damaged. More contents of the related descriptions may be found in FIG. 2 and its related descriptions.

The smart gas data center may be a platform for summarizing and storing various data, information, instructions, or the like. For example, the smart gas data center may store gas data information, gas user types, gas device information, and gas safety training programs.

In some embodiments, the smart gas indoor safety management sub-platform and the smart gas data center may be two-way interacted with each other, and include the following operations. The smart gas indoor safety management sub-platform may obtain and feed back indoor device safety management data from the smart gas data center. The smart gas data center may automatically send the acquired related safety data to the corresponding safety monitoring management module by identifying the safety parameter category (e.g., usage amount, usage times). Each safety monitoring management module may have a preset safety monitoring threshold, and when the safety data exceeds the threshold, the smart gas safety management platform may automatically alarm, and may choose to automatically push the alarm information to the gas users.

The data interaction between the smart gas safety management platform and the upper-layer smart gas service platform and the lower-layer smart gas indoor device sensor network platform may be all carried out through the smart gas data center. In some embodiments, the data interaction of the smart gas safety management platform may include the following operations. The smart gas data center may send an instruction to obtain data related to indoor gas usage to the smart gas indoor device sensor network platform. The smart gas data center may receive the data related to indoor gas usage uploaded by the smart gas indoor device sensor network platform. The smart gas data center may send the data related to indoor gas usage to the smart gas safety management sub-platform for analysis and processing. The smart gas indoor safety management sub-platform may send the processed data to the smart gas data center. The smart gas data center may send the aggregated and processed data to the smart gas service platform. The aggregated and processed data may include gas use safety information. For example, the gas usage and gas usage time within a certain period of time exceed the standard or are abnormal, etc. In some embodiments, the smart gas data center may further transmit an instruction to obtain the gas safety feedback information of the gas users to the smart gas service platform. The gas safety feedback information uploaded by the smart gas service platform may be received and different gas safety training programs for different types of users may be determined. The smart gas data center may send the determined gas safety training programs to the smart gas service platform. More descriptions of determining a gas safety training program may be found in FIG. 2 and its related descriptions.

The smart gas indoor device sensor network platform may be a platform for obtaining related data of gas device and gas usage data, and may be configured as a communication network and a gateway. In some embodiments, the smart gas indoor device sensor network platform may be configured to implement functions such as network management, protocol management, instruction management, and data analysis. The network management may be the management of the network, which may realize the data and/or information circulation among the various platforms and modules. The protocol management may be the management of various networks and communication protocols, enabling platforms and modules that execute different networks and communication protocols to exchange data and/or information. The instruction management may be the management of various instructions (e.g., instructions to obtain gas usage), and may store and execute various instructions. The data analysis may be configured to analyze various data, instructions, etc., and may analyze various data, instructions, etc., so that each module and platform may be identified or executed smoothly.

In some embodiments, the smart gas indoor device sensor network platform may interact downward with the smart gas indoor device object platform. For example, data related to indoor gas usage uploaded by the smart gas indoor device object platform may be received. Instructions to obtain data related to indoor gas usage may be issued to the smart gas indoor device object platform, etc. In some embodiments, the smart gas indoor device sensor network platform may further interact with the smart gas safety management platform. For example, instructions issued by the smart gas data center to obtain data related to indoor gas usage may be received, and the data related to indoor gas usage may be uploaded to the smart gas data center, etc.

The smart gas object platform may be a functional platform for obtaining data and/or information related to the gas-consuming end, and the data related to the gas-consuming end may mainly include gas usage data. For example, the gas usage data may include gas usage, gas alarm data, and gas maintenance data. In some embodiments, the smart gas object platform may be implemented based on corresponding device terminals, such as gas meters, valve control device, or the like.

In some embodiments, the smart gas object platform may include a fair metering device object sub-platform, a safety monitoring device object sub-platform, a safety valve control device object sub-platform, or the like. The fair metering device object sub-platform may include various metering devices such as gas flow meters, which are configured to obtain data such as gas usage. The safety monitoring device object sub-platform may include gas alarm devices, etc., which are configured to obtain the number of gas failures and failure types. The safety valve control device object sub-platform may include various valve control devices, etc., which are configured to the normal circulation and closing of gas.

In some embodiments, the smart gas object platform may interact with the smart gas indoor device sensor network platform. For example, instructions to obtain data related to gas use issued by the smart gas indoor device sensor network platform may be received, the indoor gas use related data may be uploaded to the smart gas indoor device sensor network platform, etc.

It should be noted that the above descriptions of the gas safety management Internet of Things system and its modules for gas safety training is only for convenience of description, and the present disclosure cannot be limited within the scope of the illustrated embodiments. It can be understood that for those skilled in the art, after understanding the principle of the system, various modules may be combined arbitrarily, or a subsystem may be formed to connect with other modules without departing from the principle. In some embodiments, the smart gas user platform, the smart gas service platform, the smart gas safety management platform, the smart gas indoor device sensor network platform, and the smart gas indoor device object platform disclosed in FIG. 1, may be different modules in a system, or a module may implement the functions of the above two or more modules. For example, each module may share one storage module, and each module may further have its own storage module. Such deformations are within the scope of protection of the present disclosure.

FIG. 2 may be an exemplary flowchart illustrating a gas safety management method for gas safety training according to some embodiments of the present disclosure. As shown in FIG. 2, a process 200 may include the following operations. In some embodiments, the process 200 may be performed by a smart gas safety management platform of a gas safety management Internet of Things system for gas safety training.

In operation 210, obtaining gas usage data of at least one gas-consuming end, the gas usage data including at least one of gas usage, gas alarm data, and gas maintenance data.

The gas usage data may refer to the related data generated when the user uses gas. In some embodiments, the gas usage data may include at least one of gas usage, gas alarm data, and gas maintenance data.

The gas usage may refer to the gas amount used by the user in a period of time (e.g., 1 week, 1 month, etc.). For example, the gas usage of a user in January may be 20 cubic meters, etc.

The gas alarm data may refer to the related data for alarming the gas safety problems. The gas alarm data may include alarm time points (e.g., alarm 1 week ago, alarm 1 month ago, etc.), alarm types (e.g., gas leak alarm, device aging alarm, etc.), etc.

The gas maintenance data may refer to the related data that a gas company performs maintenance on the gas device, etc. The gas maintenance data may include maintenance time points (e.g., maintenance 1 week ago, maintenance 1 month ago, etc.), maintenance types (e.g., replacement of gas valves, maintenance of gas pipelines, etc.), or the like.

In some embodiments, the gas usage data may be obtained in various ways. For example, the gas usage may be obtained through the smart gas meter, the gas alarm data may be obtained through the gas alarm device, and the gas maintenance data may be obtained through the gas maintenance department.

In operation 220, determining a user type of each of the at least one gas-consuming end based on the gas usage data of the at least one gas-consuming end, and determining a gas safety training program corresponding to each user type.

The user type may refer to type(s) of users who use gas. In some embodiments, different gas users may be classified into different user types based on different gas usage data. For example, users may be classified into residential users, commercial users, industrial users, etc. based on gas usage. For another example, users may be classified into users who are prone to gas leak, users who are prone to gas device damage, etc. based on the repair report data. For another example, users may be classified into frequent gas users, occasional gas users, etc. based on the frequency of gas usage.

In some embodiments, the user type may be obtained based on gas registration information, etc. In some embodiments, the user type may further be determined based on a preset gas usage. For example, users whose monthly gas usage is less than m₁ cubic meters are residential users, those whose monthly gas usage is greater than m₁ cubic meters, those whose monthly gas usage is less than m₂ cubic meters are commercial users, and those whose monthly gas usage is more than m₂ cubic meters are industrial users, etc. In some embodiments, the user type may further be determined based on repair report data during a period of time (e.g., 1 month, 1 year, etc.). For example, users who report gas leak more than 3 times in one year for repairs may be classified as users who are prone to gas device failure, and users who have more than 2 gas leak accidents in one year may be classified as users who are prone to gas leak. In some embodiments, the user type may further be determined based on the frequency of changes in gas statistics. For example, users whose gas statistical data changes every day are regarded as frequent gas users, and users whose gas statistical data does not change by more than a preset threshold within a week are regarded as occasional gas users. The gas statistical data may be obtained based on smart gas meters. Each user type may include at least one user.

The gas safety training program may refer to a related program for carrying out gas safety training to users. In some embodiments, the gas safety training program may include at least one of training content, training objects, training time, and push frequency.

The training content may refer to the content that the gas user receives the gas safety training, which may include test questions, videos, articles, etc. For example, videos on how to use gas correctly, gas safety knowledge test questions, etc. In some embodiments, different types of gas users may receive different training contents. For example, the training contents received by users who are prone to gas device failure are more related to the correct use and maintenance of gas device, and the training contents received by occasional gas users are more related to the maintenance and care of gas device when it is not used frequently.

The training object may be users who receive the gas safety training. For example, residential users, principals of businesses and factories, etc.

The training time may refer to the length of time during which the training object receives gas safety training. For example, the training time may be 5 minutes etc.

The push frequency may refer to the frequency at which the training contents are pushed to the training object. For example, the push frequency may be once every 3 days, once a week, etc.

In some embodiments, the training programs corresponding to different types of gas users may be different. For example, related training contents such as how to prevent and deal with large-scale fires and explosion accidents may be pushed to industrial users once a week; and the related training contents such as how to use gas properly and how to properly maintain gas device may be pushed to users who are prone to damage to gas device once every 3 days.

In some embodiments, the gas company may determine gas safety training programs based on historical data. For example, the gas safety training programs may be determined based on historical gas accident information, etc.

In some embodiments, the gas company may further push different gas safety training programs for different types of users. For example, training programs for occasional gas users may be more concerned with the proper use and maintenance of gas pipes, valves, etc. For another example, the training programs for users who are prone to gas leak may involve more on how to prevent gas leak and the disposal measures after the gas leak accident occurs.

In some embodiments, the push frequency of the gas safety training program may be positively correlated with data such as the alarm frequency of the gas alarm data, the maintenance frequency of the gas maintenance data, or the like.

In operation 230, pushing a safety training to a user terminal based on the gas safety training program.

The user terminal may refer to intelligent terminals, etc. used by gas users. For example, smart phones, computers, etc.

The safety training may refer to the related training received by gas users about the correct gas use. For example, related trainings on preventing gas leak, related trainings on preventing explosion accidents, gas safety knowledge tests, etc.

In some embodiments, the smart gas safety management platform may upload different safety trainings corresponding to different types of users to the smart gas service platform, and the smart gas service platform may push the different safety trainings to the corresponding users. The push manners may include public accounts, small programs, etc.

In operation 240, obtaining feedback information from the user terminal.

The feedback information may refer to the information that the gas user feeds back on the safety training. For example, the selection results of the answers to the safety training questions, the selection results of the answers to the questionnaire questions, etc. In some embodiments, the feedback information may be reflected in the score or accuracy rate of each training.

In some embodiments, the gas user may send the feedback information to the smart gas service platform through the smart gas user platform, and then send the feedback information to the smart gas safety management platform through the smart gas service platform to perform related operations such as aggregation and processing.

In operation 250, determining a gas safety detection frequency of the gas-consuming end of each user type, and a gas safety risk level of the gas-consuming end of each user type based on the feedback information and the gas usage data corresponding to each user type.

The gas safety detection may refer to determining different safety detection contents based on different safety risk types and probability of occurrence. For example, a pipeline detection, a gas meter detection, a gas device detection, and a gas pressure detection, etc. The gas safety detection frequency may refer to the frequency of gas safety detection. For example, once a week, once a month, etc.

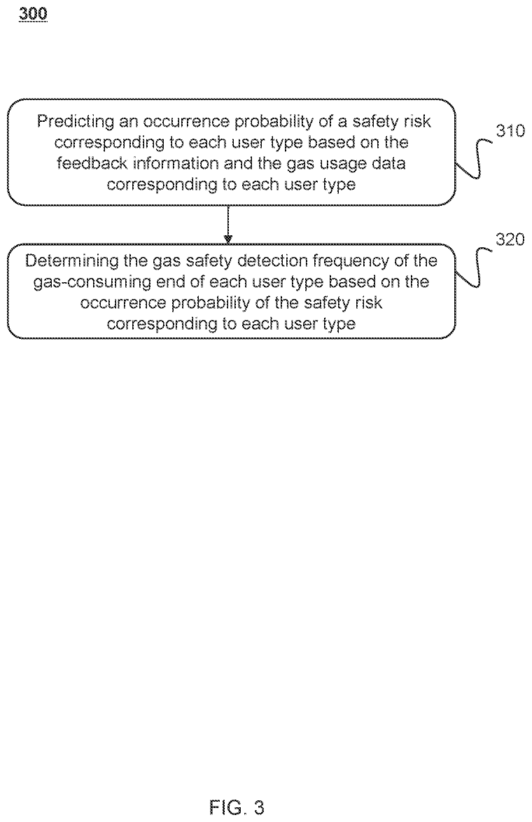

In some embodiments, the gas company may manually determine the detection frequency based on historical experience. For example, a gas company may determine the detection frequency of a gas pipeline based on the age of the pipeline device. In some embodiments, the gas safety detection frequency may further be determined based on feedback information, gas usage data, or the like. More descriptions on how to determine the gas safety detection frequency at the gas-consuming end may be found in FIG. 3 and its related descriptions.

The gas safety risk may refer to the risk of a gas safety accident. For example, pipeline leak risk, deflagration and fire risk, device aging risk, etc. The gas safety risk level may refer to the level of the possibility of gas safety accidents. The gas safety risk level may be expressed in numerical form. For example, the gas safety risk level may be represented by numbers 1˜10. The higher the gas safety risk level is, the greater the corresponding gas safety risk is.

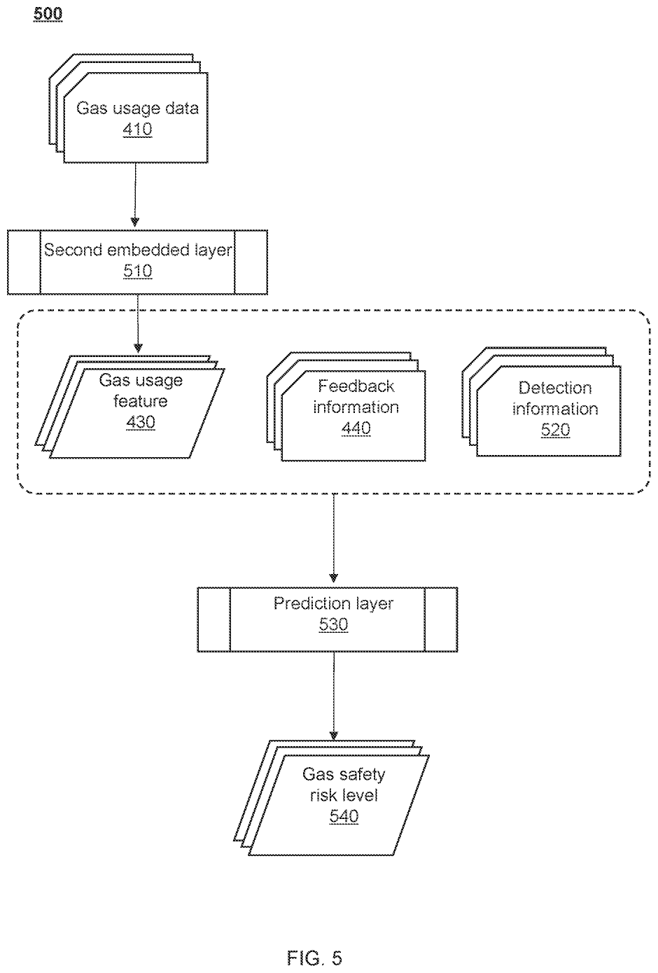

In some embodiments, the gas company may determine the gas safety risk levels of different types of users based on historical data. For example, the smart gas safety management platform may determine the gas safety risk level of at least one gas user under a certain type based on feature comparison, vector retrieval, etc., and then may determine the average value of the gas safety risk level of each gas user under this type as the gas safety risk level of the type of user. In some embodiments, the gas safety risk level may further be determined based on a machine learning model. More descriptions on how to determine the gas safety risk level at the gas-consuming end may be found in FIG. 5 and its related descriptions.

In some embodiments, the process 200 may further include the following operations.

In operation 260, updating the gas safety training program corresponding to each user type based on the feedback information corresponding to each user type.

In some embodiments, the gas safety training program may be updated based on feedback from different users. For example, users with different scores or accuracy rates may receive different safety training contents and push frequencies.

In some embodiments, updating the gas safety training program based on the feedback information of different users may include the following operations. Different intervals may be divided based on different scores, and different intervals correspond to different safety training contents. The line of the score of dividing different intervals may be preset by humans. For example, when the gas user's score is lower than 60 points, re-training is needed. When the gas user's score in a certain safety training content is higher than 95 points, the different safety training contents may be replaced. When a gas user's score is continuously low at 60 points, the push frequency may need to be increased.

In some embodiments, the processor may further classify the training objects of different types based on the feedback information. For example, the classification information of gas users may be further determined according to the score.

In some embodiments of the present disclosure, by pushing different gas safety training contents to gas users, and updating the safety training contents based on the feedback results of different users, different safety management may be carried out based on different users in a targeted manner to improve the efficiency of gas safety management and the safety awareness of gas users.

In some embodiments of the present disclosure, different gas safety training programs may be pushed in a targeted manner based on different types of gas users and different gas usage data, risk levels, etc. of different users, which may improve the efficiency of gas safety management.

FIG. 3 is an exemplary flowchart illustrating determining a gas safety detection frequency according to some embodiments of the present disclosure.

In operation 310, predicting an occurrence probability of a safety risk corresponding to each user type based on the feedback information and the gas usage data corresponding to each user type.

The occurrence probability of safety risk may refer to the occurrence probability of various gas safety accidents, for example, the probability of gas leak, the probability of deflagration, the probability of fire, the probability of device aging, etc.

In some embodiments, the occurrence probability of the safety risk corresponding to each user type may be predicted manually based on the feedback information corresponding to each user type and the corresponding gas usage data. For example, in the feedback information of the resident user, the check item of “checking whether the switch of the gas stove is turned off after use” may be displayed as “normally not checked”, then the probability of gas leak may be higher based on manual judgment.

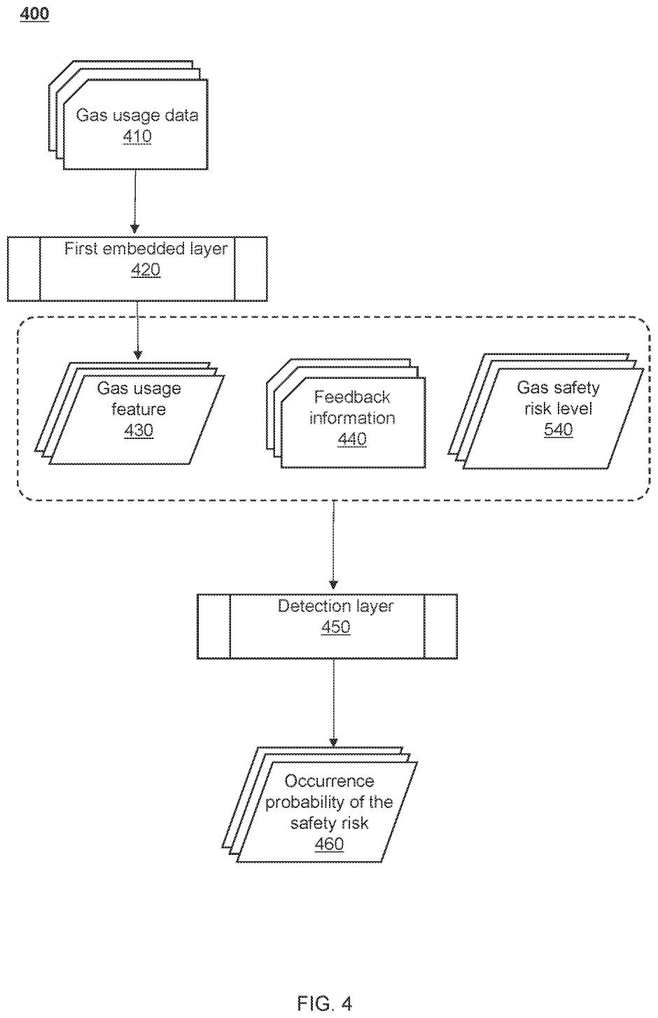

In some embodiments, the occurrence probability of the safety risk may be predicted by a detection model. More descriptions of the detection model predicting the occurrence probability of the safety risk, may be found in FIG. 4 and its related descriptions.

In operation 320, determining the gas safety detection frequency of the gas-consuming end of each user type based on the occurrence probability of the safety risk corresponding to each user type.

In some embodiments, the higher the occurrence probability of the safety risk corresponding to each user type is, the higher the gas safety detection frequency of the gas-consuming end of each user type is. For example, the higher the probability of device aging is, the higher the detection frequency of the gas device at the gas-consuming end is.

In some embodiments, there may be a mapping relationship between the occurrence probability of the safety risk and the gas safety detection frequency. For example, if the occurrence probability of safety risk is 0, the gas safety detection frequency may be once every 6 months. If the occurrence probability of safety risk is in a range of 0˜20%, the gas safety detection frequency may be once every 5 months. If the occurrence probability of safety risk is in a range of 20%˜ 40%, the gas safety detection frequency may be once every 4 months. If the occurrence probability of the safety risk is in a range of 40%˜60%, the gas safety detection frequency may be once every 3 months. If the occurrence probability of the safety risk is in a range of 60%˜80%, the gas safety detection frequency may be once every 2 months. If the occurrence probability of the safety risk exceeds 80%, the gas safety detection frequency may be once a week. The above mapping relationship is only for example, and other mapping relationships may also exist.

The mapping relationship between the occurrence probability of the safety risk and the gas safety detection frequency may be stored in a storage device or a database as a mapping table. Then, after determining the occurrence probability of the safety risk corresponding to each user type, the gas safety detection frequency of the gas-consuming end of each user type may be determined through looking up tables.

The gas safety detection frequency may be determined based on the occurrence probability of the safety risk, which may improve the accuracy of determining the gas safety detection frequency, intelligently determine a suitable gas safety detection frequency to rationalize the detection, to save labor costs, and to make gas safety management methods more economical and applicable.

It should be noted that the above descriptions of the process 200 and the process 300 are only for example and illustration, and does not limit the scope of application of the present disclosure. For those skilled in the art, various modifications and changes may be made to the process 200 and the process 300 under the guidance of the present disclosure. However, these modifications and changes are still within the scope of the present disclosure.

FIG. 4 is a schematic diagram illustrating predicting an occurrence probability of a safety risk.

In some embodiments, the smart gas safety management platform may determine the gas usage features corresponding to each user type by a first embedded layer of the detection model based on the gas usage data corresponding to each user type. In some embodiments, the smart gas safety management platform may predict the occurrence probability of safety risks corresponding to each user type through the detection layer of the detection model based on the feedback information and gas usage features corresponding to each user type, and the detection model may be a machine learning model.

The detection model 400 may be a model for predicting the occurrence probability of the safety risk. The detection model may be a machine learning model. In some embodiments, the detection model may include a convolutional neural network model or a deep neural network model.

In some embodiments, the detection model 400 may include a first embedded layer 420, and a detection layer 450. In some embodiments, the first embedded layer 420 and the detection layer 450 may be models derived from convolutional neural networks or deep neural networks or combinations thereof, or the like.

In some embodiments, the input of the first embedded layer 420 may include gas usage data 410, and the output of the first embedded layer 420 may include gas usage features 430. More descriptions of the gas usage data 410 may be found in FIG. 2 and its related descriptions. The gas usage features 430 may refer to features related to status of the gas usage. For example, the gas usage feature may include gas usage, gas usage time, gas device maintenance times, or the like. The gas usage features may be represented by a vector. For example, (2, 3, 1) may indicate that the gas usage features include that the gas usage is 2 cubic meters, the gas usage time is 3 hours, and the gas device is repaired once in the month. The gas usage features may also include other contents, such as gas usage time period, gas alarm conditions, etc.

In some embodiments, the output of the first embedded layer 420 may be configured as the input of the detection layer 450, the input of the detection layer 450 may include the gas usage features 430 and the feedback information 440, and the output of the detection layer 450 may include the occurrence probability 460 of the safety risk. More descriptions of the feedback information 440 may be found in FIG. 2 and its related descriptions. More descriptions of the occurrence probability 460 of the safety risk may be found in FIG. 3 and related descriptions.

In some embodiments, the detection model may be obtained based on a joint training of the first embedded layer 420 and the detection layer 450.

In some embodiments, the sample data of the joint training of the first embedded layer 420 and the detection layer 450 may include sample gas usage data and sample feedback information, and the label may be the occurrence of safety risks corresponding to the sample gas usage data and the sample feedback information. If there is a gas safety accident, the value of the label may be 1, and if there is no gas safety accident, the value of the label may be 0. The training samples and labels may be retrieved from storage devices or databases, and labels may be obtained based on manual annotation.

During training, the sample gas usage data may be input into the first embedded layer 420 to obtain the gas usage features output by the first embedded layer 420. The gas usage features and sample feedback information may be input into the detection layer 450 to obtain the occurrence probability of the safety risk output by the detection layer 450, a loss function may be constructed based on the occurrence probability of the safety risk and the sample occurrence probability of the safety risk, and the first embedded layer 420 may be iteratively updated based on the loss function, and the detection layer 450, until the preset condition is satisfied, the training is completed, and the trained first embedded layer 420 and the detection layer 450 may be obtained. The preset condition may be that the loss function is less than the threshold, converges, or the training period reaches the threshold.

In some embodiments, the input of the detection layer 450 may further include a gas safety risk level 540. The gas safety risk level 540 may be obtained through a risk prediction model. More descriptions of the gas safety risk level 540 may be found in operation 250 in FIG. 2 and its related descriptions. More descriptions of the safety prediction model may be found in FIG. 5 and its related descriptions.

Correspondingly, when the first embedded layer 420 and the detection layer 450 are jointly trained, the training samples of the detection layer may further include the sample safety risk level, and the rest of the training content may be similar to that descripted above in the present disclosure.

The occurrence probability of safety risk may be predicted by the detection model based on gas usage data, feedback information and gas safety risk level, the occurrence probability of safety risk may be accurately predicted, and then the accuracy of determining the frequency of gas safety detection may be improved, and the safety of gas use may be improved.

FIG. 5 is a schematic diagram illustrating determining a gas safety risk level according to some embodiments of the present disclosure.

In some embodiments, the smart gas safety management platform may determine the gas usage features corresponding to each user type through the second embedded layer of the risk prediction model based on the gas usage data corresponding to each user type. In some embodiments, the smart gas safety management platform may determine the gas safety risk level of the gas-consuming end of each user type through the prediction layer of the risk prediction model based on the gas usage features corresponding to each user type, and the risk prediction model may be a machine learning model.

The risk prediction model may be a model for predicting the gas safety risk level. The risk prediction model may be a machine learning model. In some embodiments, the risk prediction model may include a convolutional neural network model or a deep neural network model.

In some embodiments, the risk prediction model 500 may include a second embedded layer 510, and a prediction layer 530. In some embodiments, the second embedded layer 510 and the prediction layer 530 may be models derived from a convolutional neural network or a deep neural network or a combination thereof, or the like. The second embedded layer 510 may be obtained based on the parameters of the first embedded layer of the shared detection model.

In some embodiments, the input of the second embedded layer 510 may include gas usage data 410, and the output of the second embedded layer 510 may include gas usage features 430. More descriptions of the gas usage data 410 and the gas usage feature 430 may be found in FIG. 4 and its related descriptions.

In some embodiments, the output of the second embedded layer 510 may be configured as the input of the prediction layer 530, the input of the prediction layer 530 may include the gas usage feature 430, and the output of the prediction layer 530 may include the gas safety risk level 540. More descriptions of the gas safety risk level 540, reference may be found in FIG. 2, FIG. 4 and their related descriptions. The gas safety risk level 540 may be represented in the form of a level sequence. For example, the output of the prediction layer 530 is a safety risk level sequence (a, b, c), wherein a, b, and c may respectively correspond to pipeline leak risk, deflagration and fire risk, and device aging risk. Only as an example, the output of the safety risk level sequence (3, 4, 5) of the prediction layer 530 may indicate that the pipeline leak risk level is 4, the deflagration and fire risk level may be 4, and the device aging risk level may be 5. The gas safety risk level 540 may further include other types of risk levels.

In some embodiments, the risk prediction model may be obtained based on a separate training prediction layer 530, and the second embedded layer 510 in the risk prediction model may use the trained first embedded layer 420 in the detection model. In some embodiments, the training samples of the prediction layer 530 are the sample gas usage features, and the labels are the sample gas safety risk levels. The sample gas usage feature may be obtained by processing the gas usage data based on the trained first embedded layer 420 in the detection model. Training samples and labels may be retrieved from storage devices or databases, and labels may be obtained based on manual annotation. The sample gas usage features may be input into the prediction layer 530 to obtain the gas safety risk level output by the prediction layer 530, a loss function may be constructed based on the gas safety risk level and the sample gas safety risk level, and iteratively update the prediction layer 530 based on the loss function until the preset condition is satisfied, the training is completed, and the trained prediction layer 530 may be obtained. The preset condition may be that the loss function is smaller than the threshold, converges, or the training period reaches the threshold.

In some embodiments, the risk prediction model may be obtained based on a joint training of the second embedded layer 510 and the prediction layer 530.

In some embodiments, the sample data for the joint training of the second embedded layer 510 and the prediction layer 530 may include sample gas usage data, and the label may be the sample gas safety risk level. The sample gas usage data may be obtained based on the gas usage data in the training data of the first embedded layer of the shared detection model. The training samples and labels may be retrieved from storage devices or databases, and labels may be obtained based on manual annotation. The sample gas usage data may be input into the second embedded layer 510 to obtain the gas usage features output by the second embedded layer 510. The gas usage feature may be input into the prediction layer 530, the gas safety risk level output by the prediction layer 530 may be obtained, a loss function may be constructed based on the gas safety risk level and the sample gas safety risk level, and the second embedded layer 510 and the prediction layer may be iteratively updated based on the loss function 530, until the preset condition is satisfied, the training is completed, and the trained second embedded layer 510 and the prediction layer 530 may be obtained. The preset condition may be that the loss function is less than the threshold, converges, or the training period reaches the threshold.

By using the trained risk prediction model to determine the gas safety risk level, instead of manual calculation to determine the gas safety risk level, the time of predicting the gas safety risk level may be shortened to improve processing efficiency.

In some embodiments, the input of the prediction layer 530 may further include feedback information 440. More descriptions of the feedback information 440 may be found in FIG. 4 and related descriptions.

In some implementations, the input of the prediction layer 530 may further include detection information 520.

The detection information may refer to the information obtained by detection based on the gas safety detection frequency. For example, a pipeline detection, gas meter detection, gas device detection, gas pressure detection, etc. may be carried out every 3 months, and the corresponding detection results obtained may be detection information. Just as an example, the gas pipeline every 3 months may be detected to obtained the status (a, b, c, . . . ) of the gas pipeline (e.g., whether it is deformed or even damaged, etc.). The “a” may indicate whether the gas meter is in normal operation, and different values indicate different operating conditions. For example, a value of 0 may indicate abnormal operation, and a value of 1 may indicate normal operation. The “b” may indicate whether the gas device is damaged. The “c” may indicate whether the gas pressure is within a reasonable range, etc.

When the input of the prediction layer 530 further includes the feedback information 440, the training samples of the prediction layer may further include the sample feedback information when the second embedded layer 510 and the prediction layer 530 are trained, and the rest of the training may be similar to that described above in the present disclosure. When the input of the prediction layer 530 further includes detection information 520, the training samples of the prediction layer may further include sample detection information when training the second embedded layer 510 and the prediction layer 530, and the rest of the training part may be similar to that described above in the present disclosure.

Using the feedback information and the detection information as the input of the model, the accuracy of the predicted gas safety risk level of the risk prediction model may be improved, so that the predicted gas safety risk level is more in line with the actual status.

In some embodiments, the smart gas safety management platform may determine the safety reminder information corresponding to each user type based on the gas safety risk level of the gas-consuming end of each user type. In some embodiments, the smart gas safety management platform may push a safety reminder to the corresponding user terminal based on the safety reminder information corresponding to each user type.

The safety reminder information may refer to information configured to remind users about gas safety. For example, information related to pipeline safety, gas meter safety, and gas device safety, etc.

In some embodiments, if the gas safety risk level is greater than or equal to the gas safety risk level threshold, the corresponding safety reminder information may be determined, and the gas safety risk level threshold may be set to 5. For example, if the gas safety risk level related to pipeline safety is greater than or equal to the gas safety risk level threshold, the safety reminder information may be determined to be reminder information related to pipeline safety (e.g., pipeline abnormality, etc.). For another example, if the gas safety risk level related to the safety of gas device is greater than or equal to the gas safety risk level threshold, the safety reminder information may be determined to be reminder information related to the gas device safety (e.g., an abnormal thermometer and flowmeter). For example only, when the safety risk level sequence is (2, 5, 7), it may indicate that the pipeline leak risk level is 2, the deflagration and fire risk level is 5, and the device aging risk level is 7. If the risk level of deflagration and fire and the risk level of device aging are both greater than or equal to the gas safety risk level threshold (e.g., 5), the safety reminder information may be determined to be a reminder message related to deflagration and fire risk, and a reminder message related to the gas device safety. More descriptions on the safety risk level sequence may be found in the related descriptions above.

The safety reminder may be the information that is pushed and displayed on the user terminal to remind the gas safety. In some embodiments, the safety reminder may be presented by any one or a combination of pictures, text, audio, and video.

In some embodiments, the smart gas safety management platform may push the safety reminder to the corresponding user terminal based on the safety reminder information corresponding to each user type. For example, the smart gas safety management platform may push safety reminders about gas leak to users at gas leak risk, and push safety reminders about fire prevention to users at fire risk.

Pushing safety reminders to the corresponding user terminal may remind the user to pay attention to gas safety, and the safety reminders correspond to the related types of gas safety accident, reminding the user to pay attention to the gas safety in a more targeted manner, which enables users to use gas-related devices more directionally and correctly, thereby improving the management efficiency of gas safety management methods.

One or more embodiments of the present disclosure may further provide a non-transitory computer-readable storage medium storing a set of instructions, when executed by at least one processor, causing the at least one processor to perform the gas safety management method for gas safety training described.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been configured to describe embodiments of the present disclosure. For example, the terms “one embodiment,” “an embodiment,” and/or “some embodiments” mean that a particular feature, structure or feature described in connection with the embodiment is included in at least one embodiment of the present disclosure. Therefore, it is emphasized and should be appreciated that two or more references to “an embodiment,” “one embodiment,” or “an alternative embodiment” in various portions of the present disclosure are not necessarily all referring to the same embodiment. Furthermore, the particular features, structures or features may be combined as suitable in one or more embodiments of the present disclosure.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties configured to describe and claim certain embodiments of the application are to be understood as being modified in some instances by the term “about,” “approximate,” or “substantially.” For example, “about,” “approximate,” or “substantially” may indicate±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the descriptions, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A gas safety management method for gas safety training, implemented on a smart gas safety management platform based on a gas safety management Internet of Things system for gas safety training, the method comprising:
obtaining gas usage data of at least one gas-consuming end, the gas usage data including at least one of gas usage, gas alarm data, and gas maintenance data;
determining a user type of each of the at least one gas-consuming end based on the gas usage data of the at least one gas-consuming end, and determining a gas safety training program corresponding to each user type,
the gas safety training program including at least one of a training object, a training time and a push frequency;
pushing a safety training to a user terminal based on the gas safety training program;
obtaining feedback information from the user terminal; and
determining a gas safety detection frequency of the gas-consuming end of each user type, and a gas safety risk level of the gas-consuming end of each user type based on the feedback information and the gas usage data corresponding to each user type.

2. The gas safety management method for gas safety training of claim 1, wherein the feedback information is sent based on an image selection and/or a text selection; and
the method further comprises:
updating the gas safety training program corresponding to each user type based on the feedback information corresponding to each user type.

3. The gas safety management method for gas safety training of claim 2, wherein the determining a gas safety detection frequency of the gas-consuming end of each user type based on the feedback information and the gas usage data corresponding to each user type comprises:
predicting an occurrence probability of a safety risk corresponding to each user type based on the feedback information and the gas usage data corresponding to each user type; and
determining the gas safety detection frequency of the gas-consuming end of each user type based on the occurrence probability of the safety risk corresponding to each user type.

4. The gas safety management method for gas safety training of claim 3, wherein the predicting an occurrence probability of a safety risk corresponding to each user type based on the feedback information and the gas usage data corresponding to each user type, comprises:
determining a gas usage feature corresponding to each user type through a first embedded layer of a detection model based on the gas usage data corresponding to each user type; and
predicting the occurrence probability of the safety risk corresponding to each user type through a detection layer of the detection model based on the feedback information corresponding to each user type and the gas usage feature, the detection model being a machine learning model.

5. The gas safety management method for gas safety training of claim 1, wherein the determining a gas safety risk level of the gas-consuming end of each user type comprises:
determining the gas usage feature corresponding to each user type through a second embedded layer of a risk prediction model based on the gas usage data corresponding to each user type; and
determining the gas safety risk level of the gas-consuming end of each user type through a prediction layer of the risk prediction model based on the gas usage feature corresponding to each user type, the risk prediction model being a machine learning model.

6. The gas safety management method for gas safety training of claim 5, further comprising:
determining safety reminder information corresponding to each user type based on the gas safety risk level of the gas-consuming end of each user type; and
pushing a safety reminder to the user terminal based on the safety reminder information corresponding to each user type.

7. The gas safety management method for gas safety training of claim 5, wherein an input of the prediction layer further comprises the feedback information corresponding to each user type.

8. The gas safety management method for gas safety training of claim 1, wherein the gas safety management Internet of Things system for gas safety training further comprises: a smart gas user platform, a smart gas service platform, a smart gas indoor device sensor network platform, a smart gas indoor device object platform;
the gas usage data of the at least one gas-consuming end is obtained based on the smart gas indoor device object platform, and the gas usage data of the at least one gas-consuming end is transmitted to the smart gas safety management platform through the smart gas indoor device sensor network platform;
the feedback information is obtained based on the smart gas user platform, and the feedback information is transmitted to the smart gas safety management platform through the smart gas service platform; and
the method further comprises:
feeding back the gas safety training program corresponding to each user type, the gas safety detection frequency of the gas-consuming end of each user type, and the gas safety risk level of the gas-consuming end of each user type to the smart gas user platform based on the smart gas service platform.

9. The gas safety management method for gas safety training of claim 8, wherein the smart gas user platform comprises a gas user sub-platform and a supervisory user sub-platform;
the smart gas service platform comprises a smart gas-consuming service sub-platform corresponding to the gas user sub-platform, and a smart supervision service sub-platform corresponding to the supervisory user sub-platform;
the smart gas safety management platform comprises a smart gas data center and a smart gas indoor safety management sub-platform; and
the smart gas indoor device object platform comprises a fair metering device object sub-platform, a safety monitoring object sub-platform, and a safety valve control device object sub-platform.

10. A gas safety management Internet of Things system for gas safety training, comprising: a smart gas user platform, a smart gas service platform, a smart gas safety management platform, a smart gas indoor device sensor network platform, a smart gas indoor device object platform;
the smart gas indoor device object platform being configured to obtain gas usage data of at least one gas-consuming end, the gas usage data including at least one of gas usage, gas alarm data, and gas maintenance data;
the smart gas indoor device sensor network platform being configured to transmit the gas usage data of the at least one gas-consuming end to the smart gas safety management platform; and
the smart gas safety management platform being configured to:
determine a user type of each of the at least one gas-consuming end based on the gas usage data of the at least one gas-consuming end, and determine a gas safety training program corresponding to each user type,
the gas safety training program including at least one of a training object, a training time and a push frequency;
push a safety training to a user terminal based on the gas safety training program;
determine a gas safety detection frequency of the gas-consuming end of each user type, and a gas safety risk level of the gas-consuming end of each user type based on feedback information of each user type on the safety training and the gas usage data corresponding to each user type;
the smart gas service platform configured to feed back the gas safety training program corresponding to each user type, the gas safety detection frequency of the gas-consuming end of each user type, and the gas safety risk level of the gas-consuming end of each user type to the smart gas user platform based on the smart gas service platform; and
the smart gas user platform configured to obtain the feedback information of each user type on the safety training.

11. The gas safety management Internet of Things system of claim 10, wherein the feedback information is sent based on an image selection and/or a text selection;
the smart gas safety management platform be further configured to:
update the gas safety training program corresponding to each user type based on the feedback information corresponding to each user type.

12. The gas safety management Internet of Things system of claim 11, wherein the smart gas safety management platform be further configured to:
predict an occurrence probability of a safety risk corresponding to each user type based on the feedback information and the gas usage data corresponding to each user type; and
determine the gas safety detection frequency of the gas-consuming end of each user type based on the occurrence probability of the safety risk corresponding to each user type.

13. The gas safety management Internet of Things system of claim 12, wherein the smart gas safety management platform be further configured to:
determine a gas usage feature corresponding to each user type through a first embedded layer of a detection model based on the gas usage data corresponding to each user type; and
predict the occurrence probability of the safety risk corresponding to each user type through a detection layer of the detection model based on the feedback information corresponding to each user type and the gas usage feature; the detection model is a machine learning model.

14. The gas safety management Internet of Things system of claim 10, wherein the smart gas safety management platform be further configured to:
determine the gas usage feature corresponding to each user type through a second embedded layer of a risk prediction model based on the gas usage data corresponding to each user type; and
determine the gas safety risk level of the gas-consuming end of each user type through a prediction layer of the risk prediction model based on the gas usage feature corresponding to each user type, the risk prediction model is a machine learning model.

15. The gas safety management Internet of Things system of claim 14, wherein the smart gas safety management platform be further configured to:
determine safety reminder information corresponding to each user type based on the gas safety risk level of the gas-consuming end of each user type; and
push a safety reminder to the user terminal based on the safety reminder information corresponding to each user type.

16. The gas safety management Internet of Things system of claim 14, wherein an input of the prediction layer further comprises the feedback information corresponding to each user type.

17. A non-transitory computer-readable storage medium storing a set of instructions, when executed by at least one processor, causing the at least one processor to perform the gas safety management method for gas safety training of claim 1.
